(19) United States
(12) Patent Application Publication
(10) Pub. No.: US 2004/0218766 A1
(43) Pub. Date: Nov. 4, 2004

(54) 360 Degree infrared transmitter module

(76) Inventors: Daniel Keith Angell, Allen Park, MI (US); Christopher E. Andrews, South Lyon, MI (US); Neal Jonathan Todd, Chesterfield, MI (US); George Joseph DeHelian JR., Roseville, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/428,330

(22) Filed: May 2, 2003

(51) Int. Cl. H04B 1/00; H04B 5/00

(52) U.S. Cl. 381/86; 381/79

(57) ABSTRACT

A data communication system for outputting a multimedia source to occupants of a vehicle comprising an emitter unit centrally located within an interior of the vehicle and in close proximity to a headliner of the vehicle wherein the emitter unit is responsive to a data signal to transmit an infrared signal. The emitter unit further includes a source of the infrared signal in a central core of the emitter unit and directs the infrared signal in a radial direction toward an outer perimeter of the emitter unit with a first field angle. A curved deflector located on the outer perimeter of the emitter unit deflects the infrared signal throughout the interior of the vehicle with a second field angle larger than the first field angle.

### CROSS-REFERENCES TO RELATED APPLICATIONS

None.

### STATEMENT REGARDING FEDERALLY SPONSORED RESEARCH

None.

### BACKGROUND OF INVENTION

1. Field of Invention

This invention relates to a system that transmits infrared signals to multimedia devices throughout the interior of a passenger vehicle, such as an automobile.

2. Description of Related Art

Transmission of audio and video signals within a vehicle has typically been accomplished by hardwiring a multimedia source to an output device such as speakers, headphones, and video display units. As the practice of equipping a vehicle with several different types of multimedia devices becomes more prevalent, manufacturing complexity increases and additional space is needed to package and route wiring harnesses for video and audio signal transmissions. Also, as vehicle manufacturers increase the number of other electronic component control modules within the vehicle, such as safety modules, RKE modules, and the like, such modules are packaged in various concealed locations such as the interior of doors and other trim panels. As a result, vehicle manufactures must be innovative in how to accommodate the routing of wire harnesses while avoiding these populated areas. Vehicle manufacturers are constantly looking for alternative solutions so as to reduce complexity and alleviate overcrowded packaging areas.

Another issue vehicle manufacturers must take into consideration when transmitting audio and video signals through a bus system in a vehicle is electromagnetic interference (EMI). EMI generated by electrical devices may cause electrical distortion in other surrounding electrical components. In the past, audio and video signals have been very susceptible to EMI since these signals have traditionally been transmitted through wire harnesses often in close proximity to other electrical devices or an other wiring harness conducting or radiating EMI. A possible solution that has been used to suppress EMI caused by the various electrical devices is to either shield or filter the source of the EMI or the electrical device being interfered with. Filtering is performed by adding electronics such as capacitors and inductors in or at the source generating the EMI. Shielding may be installed at the source of the EMI by encasing or packaging the source of the EMI with an insulating material such as foil to prevent the radiation from escaping. Shielding can also be used on cables and wire harnesses to prevent radiation from escaping or entering into the cable or the wire harness. While electromagnetic shields and filters are commonly used to prevent the magnetic radiation from the entering or escaping the electrical devices, such prevention measures can add part complexity and cost.

Another issue when using wiring to route audio or video signals, is that when using a listening device such as headphones for receiving the audio from a multimedia output unit, either an accessible output jack or port must be located in close proximity to the listener or a headphone chord must be long enough to reach the output jack or port. In many instances, a single rear seat control unit is installed in one location having one or two output jacks or ports for the listener to plug into, such that several seating positions are relatively far away from the jacks. A further problem arises when more passengers want to listen to the multimedia program using headphones than there are available output jacks or ports. If an output jack or port is provided at each seat location for every passenger in the vehicle, wiring hardware costs are unacceptably high.

Wireless communication of audio signals using modulate infrared light is known in the art for transmitting data from a source to a receiver. Wireless headphones are devices that have been used to achieve reception of a transmitted wireless data signal in vehicles such as a DVD audio signal. However in current production systems, a transmitter is located in one particular area of the vehicle and transmits the data signal only at those passengers seated in a particular location of the vehicle. For example, a wireless audio transmitter for a DVD entertainment system is located on or near a video screen and is directed to an area of those passengers able to view the video screen. Since the data signal is substantially one directional and is transmitted to only those passengers able to view the video screen, passengers of a vehicle unable to view the video screen are not able to receive the infrared data signal. Also, a typical LED transmitter has a small coverage area. Since only a portion of the passenger area can be covered by one LED, multiple LED's and/or multiple transmitter modules must be used and placed throughout the vehicle to cover all passengers.

It would be desirable to provide a multimedia system for allowing multiple passengers in a vehicle to receive an individual audio feed for multimedia programs whereby the data signal is transmitted to every listener in a vehicle without the use of communication by wire. Such a device that uses wireless communication from an emitter unit centrally located with the interior passenger compartment of a vehicle that outputs a data signal of a plurality of multimedia devices to every passenger in a vehicle would overcome such disadvantages.

### SUMMARY

Consonant with the present invention, an emitter unit centrally located within an interior passenger compartment of a vehicle contains a source of infrared signal dispersed to a curved deflector which redirects the infrared signal in a multidirectional pattern to each passenger seated throughout the interior passenger compartment of the vehicle. The claimed invention has the advantage of using an optimum number of LEDs from a central location as opposed to using a multitude of LEDs located throughout the interior compartment of the vehicle.

A data communication system for outputting a multimedia source to occupants of a vehicle comprising an emitter unit centrally located within an interior of the vehicle and in close proximity to a headliner of the vehicle wherein the emitter unit is responsive to a data signal to transmit an infrared signal. The emitter unit further includes a source of the infrared signal in a central core of the emitter unit and directs the infrared signal in a radial direction toward an outer perimeter of the emitter unit with a first field angle. A curved deflector located on the outer perimeter of the emitter unit deflects the infrared signal throughout the interior of the vehicle with a second field angle larger than the first field angle.

### BRIEF DESCRIPTION OF THE DRAWINGS

A more complete appreciation of the present invention and many of its advantages will be readily obtained as they become better understood by reference to the following detailed description when considered in connection with the accompanying drawings and detailed specification.

FIG. 1 is a view of an interior compartment of a vehicle showing a vehicle entertainment system and emitter unit.

FIG. 2 is a side view of an emitter unit according to the first embodiment.

FIG. 3 a side view of an emitter illustrating a dispersion of an infrared signal according to the first embodiment of FIG. 2.

FIG. 4 a side view of an emitter unit for a wireless transmission system according to a second embodiment.

FIG. 5a and 5b illustrate a top view and a side view of an emitter unit for a wireless transmission system according to a third embodiment.

FIG. 6a and 6b illustrate a top view and aside view of an emitter unit for a wireless transmission system according to a fourth embodiment.

### DETAILED DESCRIPTION OF THE PREFERRED EMBODIMENTS

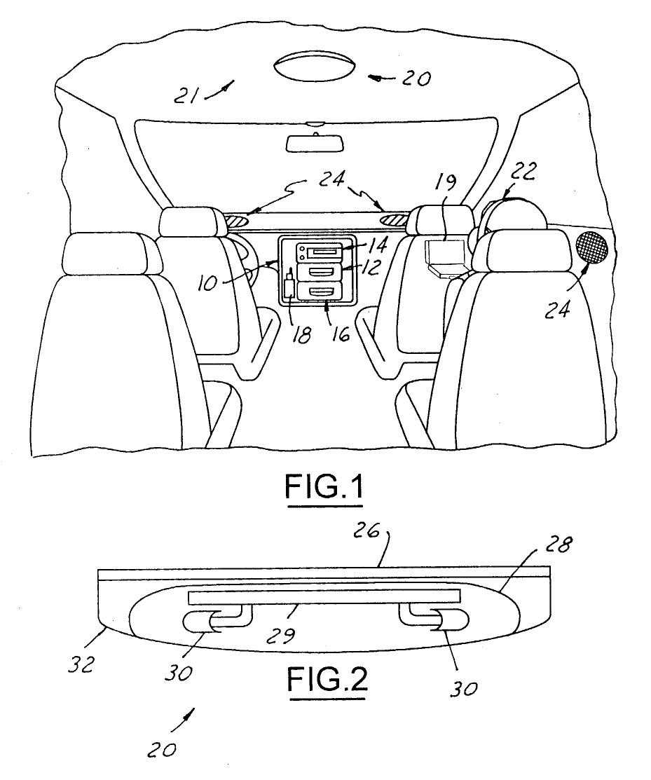

Referring now to the Drawings and particularly to FIG. 1, there is shown a vehicle entertainment system within an interior of a vehicle according to the present invention. The vehicle entertainment system comprises at least one multimedia device for outputting a multimedia program to the occupants of the vehicle. A multimedia device, also known as a reproduction device, could be a radio receiver 10, a CD player 12, a tape player 14, a DVD player 16, or a mobile phone 18. Other multimedia devices may include MP3 players, television receivers, digital video players, satellite videos, personal audio players, personal video players, or a hard drive system. An emitter unit 20 is mounted in a central location within the interior compartment and attached to or in close proximity to a headliner 21. Alternatively, the emitter unit 20 may be mounted in other locations within the vehicle such as a console surface, but optimally a preferred location is one where the emitter unit 20 is at an even distance and unobstructed to all passengers within the vehicle. Receiving units such as a wireless headphone 22 worn by occupants, wireless speakers 24, or a video screen module 19 situated throughout the vehicle receive wireless information from the multimedia devices and generate an audio or video output. The receiving units usually consist of an infrared detector for detecting and receiving the infrared signal, a demodulator for recovering an audio signal from a modulated signal, and a speaker to output the audio content. Alternatively, the wireless information signal can be a control signal, text data, or other information signals depending on the multimedia application.

FIG. 2 illustrates a preferred embodiment of an emitter unit for a wireless transmission system according to the present invention. The emitter unit 20 is a light wave transmitter for irradiating a wireless information signal throughout the vehicle. The wireless information signal is preferably an audio signal or video signal using infrared light as a communication medium. The emitter unit 20 comprises a mounting bezel 26 for attaching to the interior of the vehicle such as a headliner, a transmission circuit board 29 attached directly or indirectly to the mounting bezel 26, a plurality of infrared LEDs 30 located at the center core about the inner perimeter of the emitter unit 20, a curved deflector 28 located about the outer perimeter, and a protective cover 32. The transmission circuit board 29 receives a data signal from the reproduction device. The reproduction device, as described earlier is any multimedia device that transmits the data signal containing multimedia content. The data signal can be a live broadcast signal or a recorded broadcast signal. The data signal transmitted from the reproduction device to the transmission circuit board 29 can be a wireless signal or transmitted conventionally through a wire or a bus system. A pin photodiode is a type of photodecter that may be used to receive the data signal if the data signal is transmitted by a light-wave medium. An IrDA standard may be used as a communication protocol for transmitting and receiving information using infrared-light waves.

An infrared LED generally has a focused beam spread providing a relatively narrow field angle. In order to obtain a large area of coverage without having to use a multitude of the infrared LEDs positioned in an x-plane, y-plane, and z-plane would be to increase the beam spread of the LED which would thereby increase the field angle. In this embodiment, the plurality of infrared LEDs 30 are electrically attached to the transmission circuit board 29 using leads and are positioned around the perimeter of the circuit board in a 360-degree pattern in a single plan. Alternatively, the plurality of infrared LEDs 30 could be attached without the use of leads such as a surface mount device. The plurality of infrared LEDs are positioned so that the infrared signal is dispersed radially each at a first field angle in the direction of the curved deflector 28 located about the outer perimeter of the emitter unit. In addition, a portion of the infrared signal may be irradiated directly from the plurality of LEDs 30 through protective cover 32 to the interior of the vehicle without contacting the curved deflector 28.

The curved deflector 28 is a 360-degree annular reflective surface made of any reflective material that reflects infrared light such as a mirrored surface. When viewing a cross section of the curved deflector 28, the reflecting surface is parabolic shaped so that the reflected infrared light is defocused and the beam spread is increased. The infrared signal is projected downward by the curved deflector 28 at a second field angle in a multi-directional pattern to the receiving units located throughout the interior of the vehicle, wherein the second field angle is larger than the first field angle. The protective cover 32 attaches to the mounting plate 26 encasing the plurality of infrared LEDs 30. The protective cover 32 can be made of any infrared transparent material that will not interfere or obstruct the infrared signal.

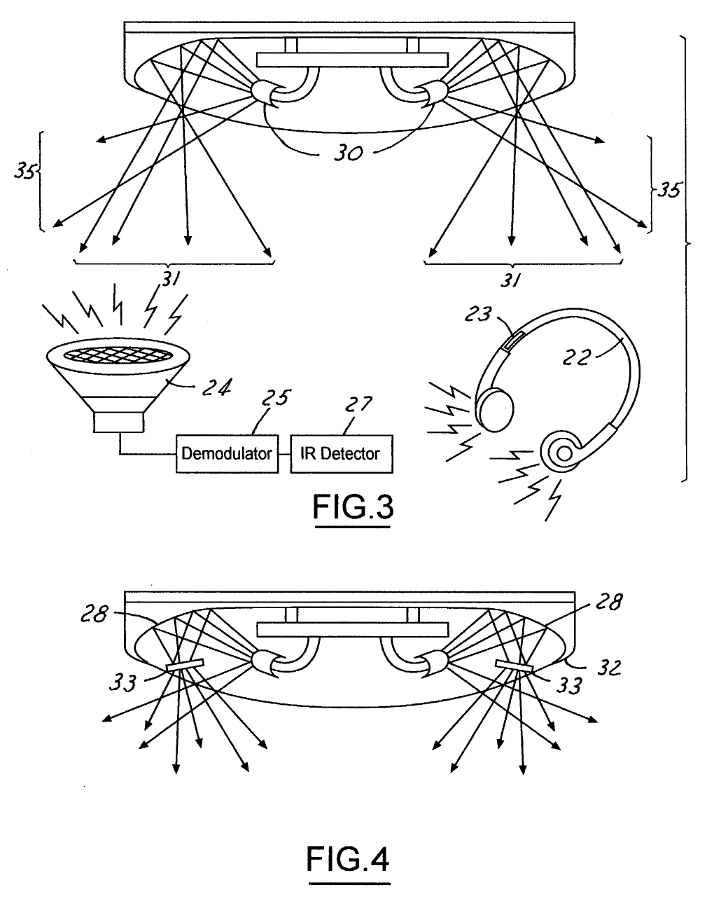

FIG. 3 illustrates a dispersion of the infrared signal according to the preferred embodiment of FIG. 2. The first portion 31 of the infrared signal directed at the curved deflector 28 is reflected through the protective cover 32 to the interior compartment of the vehicle. A second portion 35 of the infrared signal may be directly irradiated through the protective cover to the interior compartment of the vehicle depending on the positioning of the plurality of infrared LEDs 30. Occupants wearing the wireless headphone 22 or other receiving units such as the speakers 24 or the video screen module located throughout the interior compartment of the vehicle receive the infrared signal containing the multimedia content. An infrared detector 27, such as a photocell, receives the infrared signal in a modulated format and converts the infrared signal into a modulated electrical signal. A demodulator 25 then recovers the audio signal from a modulated electrical signal and the speakers 24 convert the electrical signal into sound. The wireless headphone 22 also has a receiver 23 which contains a photocell and demodulator for receiving and converting the infrared signal into sound.

FIG. 4 illustrates an emitter unit for a wireless transmission system according to a second preferred embodiment. The emitter unit 20 includes a beam modifier 33 located between the curved deflector 28 and the protective cover 32. The beam modifier 33 may comprise a refractive surface. As the infrared signal disperses from the curved deflector 28, the infrared signal propagates with a certain beam spread angle. While passing through the beam modifier 33, the direction and the speed of propagation of the infrared signal are changed so as to refract the infrared signal so as to de-focus even more. Thus, the beam spread angle is increased as the infrared signal irradiates from the beam modifier 33. As a result, the infrared signal irradiates to a larger receiving area can within the interior compartment of the vehicle. Alternatively, the beam modifier 33 may use other types of deflective surfaces such as a diffractive or a diffusion surface to increase the beam spread of the infrared signal.

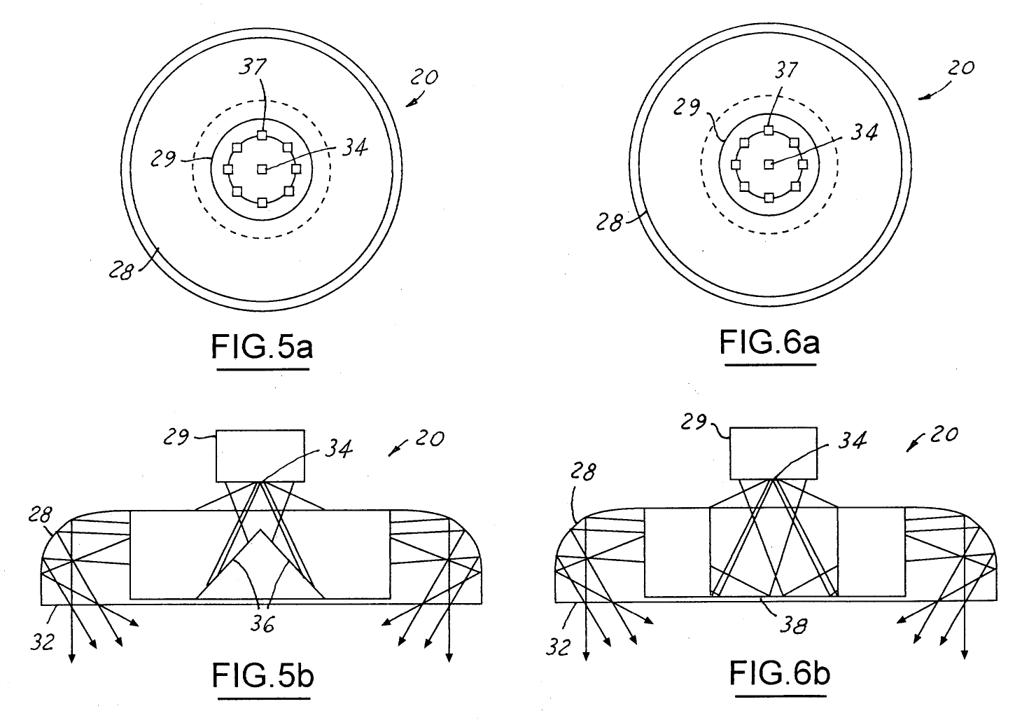

FIG. 5a and FIG. 5b illustrates a top view and a side view, respectively of an emitter unit for a wireless transmission system according to a third preferred embodiment. A surface mount LED 34 is located at a top surface inside the emitter unit 20. The surface mount LED 34 projects an infrared signal downward in a vertical direction. Alternatively, a plurality of surface mount LEDs 37 forming an array could be utilized as shown in FIG. 5b. The emitter unit 20 includes a reflector surface 36 located directly below the surface mount LED 34 in the center core of the emitter unit 20. The reflector surface 36 can be made of any material that reflects infrared light such as a white specular or a mirrored surface. The reflector surface 36 is a circular apex molded into the emitter unit 20. Alternatively, the circular apex can be an insert within the emitter unit 20. The circular apex has a largest diameter at the base of the circular apex located on or in close proximity to the protective cover 32. The diameter of the circular apex increasingly narrows as the circular apex approaches the surface mount LED 34. When the surface mount LED 34 disperses the infrared signal toward the reflective surface 36, the infrared signal is redirected to the outer perimeter of the emitter unit 20 by the circular apex and toward the curved deflector 28. The curved deflector 28 thereafter irradiates the infrared signal throughout the interior compartment to receiving units located within the vehicle.

FIG. 6a and FIG. 6b illustrates a top view and a side view, respectively, of an emitter unit for a wireless transmission system according to a fourth preferred embodiment. As in FIG. 5, a surface mount LED 34 is located at a top surface inside the emitter unit 20. The surface mount LED 34 is projecting downward in a vertical direction. A diffuser surface 38 located about the center core on the bottom of the emitter unit 20 is attached to or in close proximity to the protective cover 32. The diffuser surface 38 can be an insert or molded into the protective cover 32. The surface mount LED 34 disperses the infrared signal toward the diffusion surface 38. A characteristic of the diffusion surface 38 is that the infrared signal is spread about diffusion surface 38 and redirected to the outer perimeter toward the curved deflector 28. Alternatively, the diffusion surface can be made of a translucent material doped with a reflective material so that a portion of the infrared signal is propagated through the diffusion surface 38 while a portion of the infrared signal is redirected to the curved deflector 28.

A fifth preferred embodiment would be to utilize in place of the diffuser surface (as described in FIG. 6.) a diffractive surface. A diffractive surface would use parallel lines or grooves spaced close together to produce a scattering effect of the infrared signal and redirect the infrared signal toward the curved deflector 28.

From the foregoing description, one ordinarily skilled in the art can easily ascertain the essential characteristics of this invention and, without departing from the spirit and scope thereof, can make various changes and modifications to the invention to adapt it to various usages and conditions. For example, although only one design is shown to use a plurality of LEDs locate about the of a circuit transmission board, it will be readily apparent to those skilled in the art to utilize a flex circuitry to attach the infrared LEDs and wrap in a 360 degree circumference to attain the same coverage zones as discussed above. Also, although the preferred embodiment is shown to implement the vehicle entertainment system in an automobile vehicle, it will be readily apparent to those skilled in the art that the vehicle entertainment system can be implemented in any transportation device such as trucks, boats, planes, or trains.

We claim:

1. A data communication system for outputting a multimedia source to occupants of a vehicle comprising:
an emitter unit centrally located within an interior of said vehicle and in proximity to a headliner of said vehicle, said emitter unit responsive to a data signal to transmit an infrared signal, said emitter unit including:
a source of said infrared signal in a central core of said emitter unit and directing said infrared signal in a radial direction toward an outer perimeter of said emitter unit with a first field angle; and
a curved deflector located on said outer perimeter of said emitter unit for deflecting said infrared signal throughout said interior of said vehicle with a second field angle larger than said first field angle.

2. The data communication system as in claim 1 wherein said curved deflector is a substantially parabolic reflector disposed annularly around said core.

3. The data communication system as in claim 1 further comprising a refractive surface located below said curved deflector wherein said refracting surface receives said infrared signal from said curved deflector and further increases a field angle of said infrared signal.

4. The data communication system as in claim 1 wherein said of source of said infrared signal comprises an infrared LED.

5. The data communication system as in claim 1 wherein source of said infrared signal comprises a plurality of infrared LEDs located about an inner perimeter of said central core.

6. The data communication system as in claim 1 further comprising an infrared emitter generating said infrared signal and mounted coaxial with said core, and a second deflector located about an inner perimeter of said emitter unit for redirecting said infrared signal directed axially at said core to said outer perimeter.

7. The data communication system as in claim 6 wherein said second deflector is a reflective surface.

8. The data communication system as in claim 6 wherein said second deflector is a refractive surface.

9. The data communication system as in claim 6 wherein said second deflector is a diffractive surface.

10. The data communication system as in claim 6 wherein said second deflector is a diffusion surface.

11. A data communication system as in claim 1 further comprising a protective cover encasing said emitter unit wherein said protective cover is made of a infrared transparent material to allow said infrared signal transmit through said protective cover to the interior compartment of the vehicle.

12. A data communication system as in claim 1 wherein said data signal is coupled to said emitter unit as a wireless signal.

13. A data communication system as in claim 1 wherein said data signal is coupled to said emitter unit as a modulated signal.

14. The data communication system of claim 1 wherein said infrared signal is a modulated signal.

15. The data communication system of claim 1 further comprising a receiving unit for receiving said infrared signal and recovering said data signal.

16. The data communication system of claim 15 wherein said receiving unit is a wireless headphone.

17. The data communication system of claim 15 wherein said receiving unit comprises an infrared detector, a demodulator, and a speaker.

18. A vehicular multimedia system comprising:
a multimedia source outputting a data signal to an interior of a vehicle;
a data communication system including an emitter unit centrally located within said interior of said vehicle and in proximity to a headliner of said vehicle, said emitter unit responsive to said data signal to transmit an infrared signal, said emitter unit including:
a source of said infrared signal in a central core of said emitter unit and directing said infrared signal in a radial direction toward an outer perimeter of said emitter unit with a first field angle; and
a curved deflector located on said outer perimeter of said emitter unit for deflecting said infrared signal throughout said interior of said vehicle with a second field angle larger than said first field angle.

19. The data communication system of claim 18 wherein said multimedia source includes a CD player and said data signal is CD audio.

20. The data communication system of claim 18 wherein said multimedia source includes an MP3 player and said data signal is MP3 audio.

21. The data communication system of claim 18 wherein said multimedia source includes a tape player and said data signal is tape audio.

22. The data communication system of claim 18 wherein said multimedia source includes a DVD player and said data signal is DVD audio.

23. The data communication system of claim 18 wherein said multimedia source includes a broadcast radio receiver and said data signal is radio audio.

24. The data communication system of claim 18 wherein said multimedia source includes a television receiver and said data signal is television audio.
